(19) United States
(12) Patent Application Publication
(10) Pub. No.: US 2010/0264196 A1
(43) Pub. Date: Oct. 21, 2010

(54) ELECTRONIC COMPONENT MOUNTING METHOD

(75) Inventors: Yuzuru Inaba, Yamanashi (JP); Masafumi Inoue, Yamanashi (JP)

Correspondence Address: PEARNE & GORDON LLP, 1801 EAST 9TH STREET, SUITE 1200, CLEVELAND, OH, 44114-3108, US

(73) Assignee: Panasonic Corporation, Osaka (JP)

(21) Appl. No.: 12/761,578

(22) Filed: Apr. 16, 2010

(30) Foreign Application Priority Data
Apr. 17, 2009 (JP) P2009-100520

(51) Int. Cl. B23K 31/02

(52) U.S. Cl. 228/102

(57) ABSTRACT

In electronic component mounting operation for mounting an electronic component having bumps provided on its lower surface to a substrate by soldering, solder paste is printed on electrodes, and positions of the solder paste are detected in print inspection. An inspection result is output as solder paste position data. In a resin coating process where corners are previously coated with reinforcing resin, control parameters of a coating device that applies the reinforcing resin are updated in accordance with solder paste position data, thereby correcting positions where the coating device applies the reinforcing resin. Mixed application of the reinforcing resin on the already-printed solder paste can thereby be prevented.

### BACKGROUND OF THE INVENTION

1. Field of the Invention

The present invention relates to an electronic component mounting method for mounting an electronic component on a substrate by an electronic component mounting system including a plurality of devices for use in mounting an electronic component.

2. Related Art

A method widely used as a technique for mounting an electronic component, such as a semiconductor device, on a substrate is to bond a connection terminal, like a bump, formed on a semiconductor device from a bonding material, such as solder, to an electrode on the substrate with the bonding material, such as solder, and to bring the connection terminal into electrical connection with the electrode. In many cases, mere bonding of the connection terminal to the electrode results in generation of insufficient retaining force for retaining the electronic component on the substrate. For this reason, reinforcing the electronic component and the substrate with a thermosetting resin, like an epoxy resin, is usually carried out.

A hitherto method widely used for resin reinforcement is to mount electronic components and subsequently fill clearance between a substrate and the electronic components with underfill resin. However, as miniaturization of electronic components recently proceeds, greater difficulty is encountered in filling clearance between the substrate and the electronic components with resin. For this reason, so-called “resin precoating”; namely, applying reinforcing resin along with a bonding material, such as solder paste, before mounting of an electronic component, is used as a method for reinforcing a mounted electronic component with resin (see JP-A-2005-26502). The example patent document shows an exemplification in which an adhesive (reinforcing resin) for use with an electronic component that exhibits a property of not hindering self-alignment achieved by solder bonding is previously applied to predetermined positions on a substrate after printing of solder on the substrate in order to join the substrate to the electronic components mounted on the substrate by solder bonding, to thus strengthen retaining force.

However, the related art, including the prior art described in connection with JP-A-2005-26502, encounters the following problem ascribable to a correlation between the precision of a printing position achieved during solder printing performed before mounting of components and the precision of a coating position achieved during coating of a reinforcing resin. Specifically, printing operation is performed while electrodes on a substrate are taken as target printing positions in solder printing. However, in reality, solder is not always, correctly printed on positions of the electrodes for reasons of various error factors in printing processes, and given tendency of positional displacement is generally exhibited.

However, during application of reinforcing resin performed subsequent to solder printing, application operation is likewise controlled while the positions of the electrodes are taken as a reference. Therefore, when the tendency of positional displacement of printing positions achieved during solder printing and the tendency of positional displacement of coating positions achieved during application of reinforcing resin are opposite to each other, reinforcing resin is resultantly applied to the position extremely close to printed solder. Depending on a degree of closeness, the solder and the reinforcing resin overlap each other, to thus become partially mixed together. Such mixing of the solder serving as a bonding material and the reinforcing resin adversely affects a joining characteristic of solder, which in turn results in deterioration of mounting quality.

### SUMMARY OF THE INVENTION

Accordingly, the present invention aims at providing an electronic component mounting method that prevents mixing of a bonding material with reinforcing resin, to thus assure mounting quality, in connection with a mounting mode using the bonding material in conjunction with the reinforcing resin.

An electronic component mounting method of the present invention is directed toward an electronic component mounting method for manufacturing a mounted substrate by bonding electronic components to a substrate by use of a bonding material in an electronic component mounting system including a plurality of electronic component mounting devices, the method comprising:

a bonding material feeding process of feeding the bonding material to electrodes for bonding the electronic components formed on the substrate by a printing device;

a bonding material position detection process of detecting position of the bonding material fed in the bonding material feeding process by a print inspection device and outputting a result of position detection as bonding material position data;

a resin coating process of coating the substrate after the bonding material position detection process with reinforcing resin that reinforces retaining force for retaining the electronic components on the substrate such that the electronic components are implemented by a resin coating section;

an implementing process of taking the electronic components out of a component feeding section by an implementing head and implementing the electronic components on the substrate supplied with the bonding material and additionally coated with the reinforcing resin; and

a heating process of heating the substrate by a solder bonding unit, to thus bond the implemented electronic components to the substrate by the bonding material and thermally setting the reinforcing resin, to thus retain the electronic components on the substrate;

wherein control parameters for controlling the resin coating section are updated in the resin coating process in accordance with the bonding material position data.

According to the present invention, it is possible to prevent mixing of the boding material with the reinforcing resin, to thus assure mounting quality, in a mounting mode in which the reinforcing resin is used in conjunction with the bonding material by updating the control parameters for controlling the resin coating section in accordance with the bonding material position data during the resin coating process of detecting the positions of the bonding materials supplied to the electrodes in the bonding material feeding process, outputting a result of position detection as the bonding material position data, and applying the reinforcing resin for reinforcing retaining force to retain the electronic component on the substrate by the resin coating section.

### BRIEF DESCRIPTION OF THE DRAWINGS

FIG. 1 is a block diagram showing a configuration of an electronic component mounting system of an embodiment of the present invention;

FIG. 2 is a block diagram showing a configuration of an inspection device of the electronic component mounting system of the embodiment of the present invention;

FIG. 3 is a block diagram showing a configuration of a screen printer of the electronic component mounting system of the embodiment of the present invention;

FIG. 4 is a block diagram showing a configuration of a coating device of the electronic component mounting system of the embodiment of the present invention;

FIG. 5 is a block diagram showing a configuration of an electronic component implementing device of the electronic component mounting system of the embodiment of the present invention;

FIG. 6 is a block diagram showing a configuration of a reflow device of the electronic component mounting system of the embodiment of the present invention;

FIG. 7 is a block diagram of a control drive of the electronic component mounting system of the embodiment of the present invention;

FIGS. 8A to 8E are drawings providing explanations about processes of component mounting operation in an electronic component mounting method of the embodiment of the present invention;

FIGS. 9A to 9C are explanatory views of detection of positional displacement of the electronic component mounting method of the embodiment of the present invention;

FIGS. 10A to 10C are explanatory views of a result of detection of positional displacement in the electronic component mounting method of the embodiment of the present invention;

FIGS. 11A to 11C are explanatory views of correction of a reinforcing resin application position in the electronic component mounting method of the embodiment of the present invention;

FIGS. 12A to 12C are explanatory views of correction of the reinforcing resin application position in the electronic component mounting method of the embodiment of the present invention; and

FIG. 13 is a block diagram showing the configuration of the electronic component mounting system of the embodiment of the present invention.

### DETAILED DESCRIPTION OF THE PREFERRED EMBODIMENTS

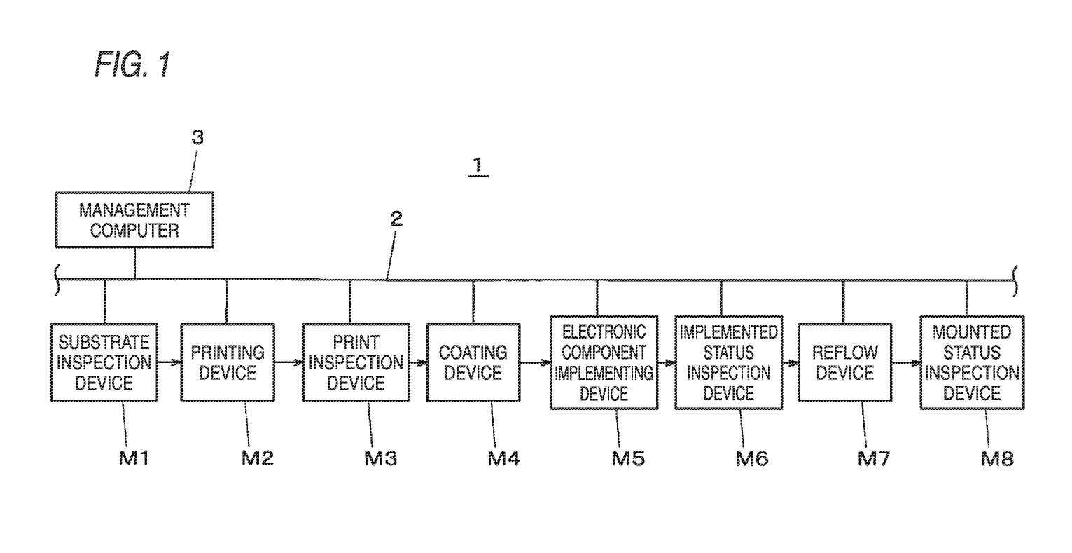

An electronic component mounting system is first described by reference to FIG. 1. The electronic component mounting system is arranged in such a way that an electronic component mounting line 1 built by linkages among a plurality of electronic component mounting devices; namely, a substrate inspection device M1, a printing device M2, a print inspection device M3, a coating device M4, an electronic component implementing device M5, an implemented status inspection device M6, a reflow device M7, and a mounted status inspection device M8, is connected by a communication network 2, thereby controlling the entirety of the line by a management computer 3.

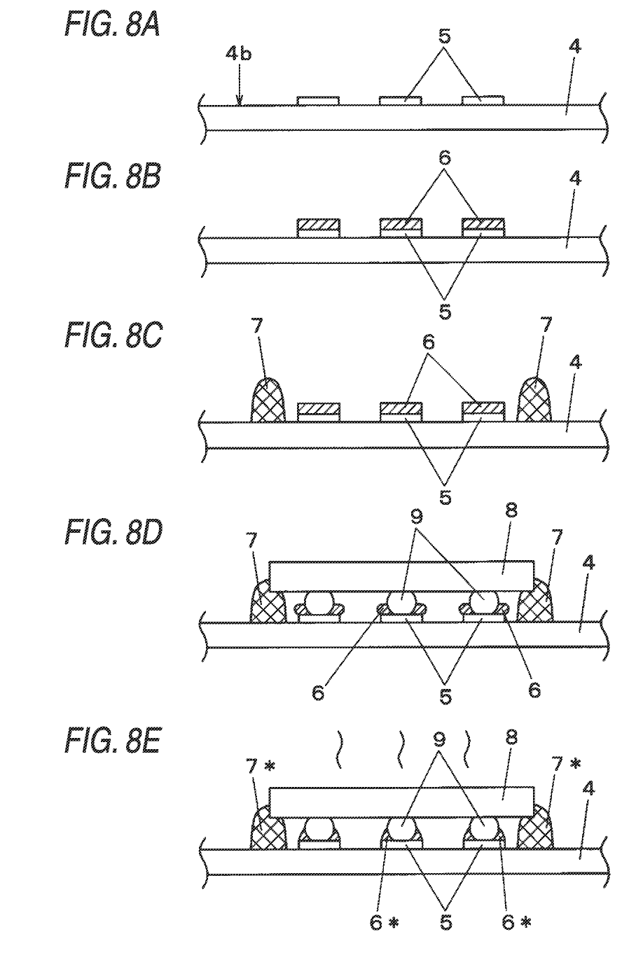

Under an electronic component mounting method for use with the electronic component mounting system, electronic components are bonded to a substrate 4 (see FIG. 8A), which has electrodes 5 formed on its upper mounting surface 4b, with a bonding material, such as solder paste made by causing a flux component to contain solder particles, thereby manufacturing a mounting board. An example electronic component is mounted by soldering to the substrate 4 a bump-equipped electronic component 8 (see FIGS. 8A to 8E), such as a BGA, that assumes a rectangular shape when viewed from top and that has on a lower surface thereof a plurality of bumps formed as connection terminals.

The substrate inspection device M1 inspects electrodes formed on the substrate 4. As shown in FIG. 8B, the printing device M2 supplies solder paste 6 to the electrodes 5 for electronic component bonding purpose formed on the substrate 4, by means of screen printing technique. The print inspection device M3 inspects a printed status of the substrate 4 having undergone printing. Specifically, positions of solder paste 6 supplied by the printing device M2 are detected, and a result of detection of the positions is output as solder paste (bonding material) position data. The coating device M4 is a resin application section and applies reinforcing resin 7, which strengthens retaining force for retaining the electronic components 8 on the substrate 4 printed with the solder paste 6, to the substrate 4 while the electronic components 8 are mounted on the substrate, as shown in FIG. 8C. The present embodiment shows an example in which corners of the rectangular electronic component 8 are taken as areas to be reinforced. Resin containing thermosetting resin as a principal ingredient is used as the reinforcing resin 7, such as an epoxy resin.

As shown in FIG. 8D, the electronic component implementing device M5 implements the electronic component 8, which has bumps 9 formed on its lower surface, on the substrate 4 that is printed with the solder paste 6 and additionally coated with the reinforcing resin 7, by use of an implementation head. The bumps 9 land on respective upper surfaces of the corresponding electrodes 5 by way of the solder paste 6, and the respective corners of the electronic component 8 contact the reinforcing resin 7 previously applied to the substrate 4. The implemented status inspection device M6 (a second inspection device) inspects presence/absence or positional displacement of the electronic component 8 on the substrate 4 on which the component has been implemented. The reflow device M7 (solder bonding unit) heats the substrate on which the component has been implemented, thereby soldering the electronic component 8 to the substrate 4 as shown in FIG. 8E. The bumps 9 are thereby soldered to the electrodes 5 by way of solder bonded portions 6* resulting from fusion and solidification of the solder paste 6. Further, the electronic component 8 is retained by the substrate 4 at the corners of the electronic component 8, by resin reinforced portions 7* resulting from thermal setting of the reinforcing resin 7. The implemented status inspection device M8 (a third inspection device) inspects an implemented status of the soldered electronic component 8 on the substrate 4.

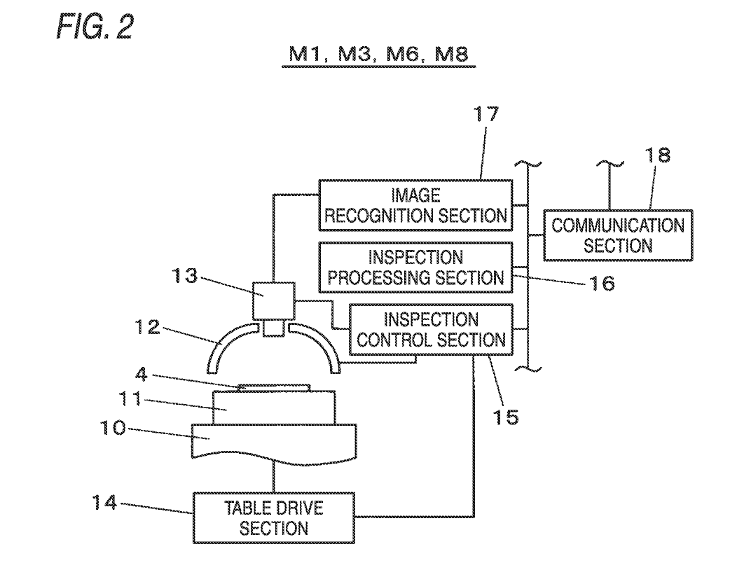

Configurations of the respective devices will now be described. First, the inspection devices used as the substrate inspection device M1, the print inspection device M3, the implemented status inspection device M6, and the implemented status inspection device M8 are now described by reference to FIG. 2. In FIG. 2, a substrate retaining section 11 is placed on a positioning table 10, and the substrate retaining section 11 holds the substrate 4. A camera 13 is placed at a position above the substrate retaining section 11 while its photographing direction is downwardly oriented. The camera 13 photographs an image of the substrate 4 while an illumination section 12 provided around the camera is illuminated. The positioning table 10 is driven at this time by controlling a table drive section 14, whereby photographing can be performed while an arbitrary position on the substrate 4 is located immediately below the camera 13.

An image recognition section 17 subjects image data acquired by photographing to image processing, whereupon a predetermined recognition result is output. An inspection processing section 16 conducts a pass/fail test for each inspection item in accordance with the recognition result. In relation to predetermined items, a detection value is output as feedback data or feedforward data. The thus-output data are transferred to the management computer 3 and another device by way of a communication section 18 and the communication network 2. An inspection control section 15 controls the table drive section 14, the camera 13, and the illumination section 12, thereby controlling inspecting operation.

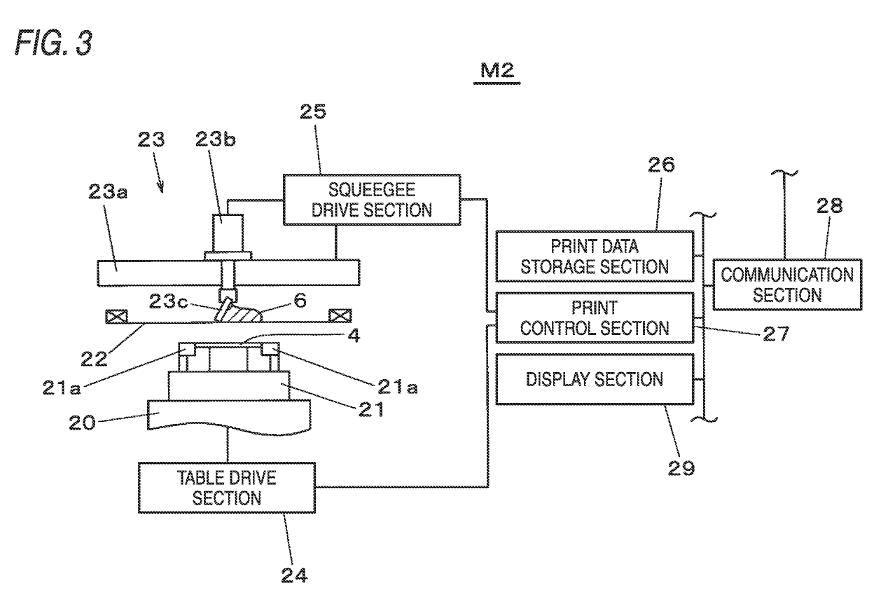

The configuration of the printing device M2 is now described by reference to FIG. 3. In FIG. 3, a substrate retaining section 21 is placed on a positioning table 20. The substrate retaining section 21 retains the substrate 4 while the same is clamped between clampers 21a. A mask plate 22 is placed above the substrate retaining section 21, and pattern holes (not shown) corresponding to printing areas on the substrate 4 are provided in the mask plate 22. A table drive section 24 drives the positioning table 20, whereby the substrate 4 moves in both horizontal and vertical directions with respect to the mask plate 22.

A squeegee section 23 is placed above the mask plate 22. The squeegee section 23 includes a lifting press mechanism 23b that causes a squeegee 23c to ascend or descend with respect to the mask plate 22 and that presses the squeegee 23c against the mask plate 22 at predetermined pressing force (printing pressure) and a squeegee movement mechanism 23a for horizontally actuating the squeegee 23c. The lifting press mechanism 23b and the squeegee movement mechanism 23a are driven by a squeegee drive section 25. The squeegee 23c is horizontally moved at predetermined speed along a surface of the mask plate 22 supplied with the solder paste 6 while the substrate 4 remains in contact with the lower surface of the mask plate 22, whereby the solder paste 6 is printed on an upper surface of the substrate 4 by way of an unillustrated pattern hole.

A print control section 27 controls the table drive section 24 and the squeegee drive section 25, whereby printing operation is performed. On the occasion of control operation, operation of the squeegee 23c and positioning of the substrate 4 to the mask plate 22 are controlled in accordance with print data stored in a print data storage section 26. A display section 29 displays various sets of index data showing an operating status of the printing device and an anomaly alarm showing an anomaly in the status of printing operation. A communication section 28 exchanges data between the management computer 3 and other apparatus making up the electronic component mounting line 1 by way of the communication network 2.

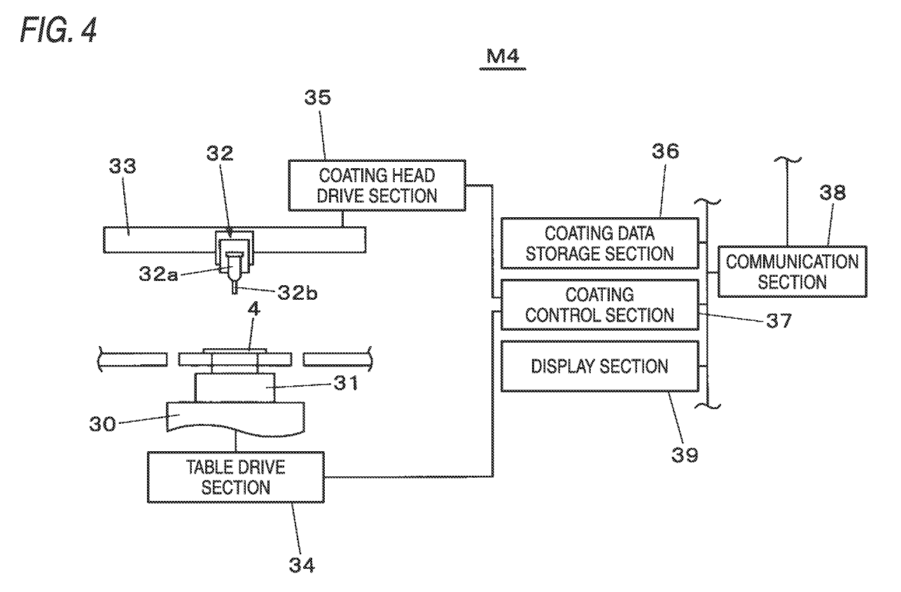

The configuration of the coating device M4 is now described by reference to FIG. 4. In FIG. 4, a substrate retaining section 31 is placed above a positioning table 30, and the substrate retaining section 31 retains the substrate 4 conveyed from the print inspection device M3. A coating head 32 that is actuated by a head drive mechanism 33 is placed above the substrate holding section 31. The coating head 32 is equipped with a syringe 32a, which preserves the reinforcing resin 7, in a freely ascending/descending manner. A lower end of the syringe 32a is equipped with a coating nozzle 32b, and the syringe 32a is lowered to coating target areas on the substrate 4. The reinforcing resin 7 is squirted from the coating nozzle 32b, whereby the coating target areas (areas corresponding to the corners of the implemented electronic component 8) on the substrate 4 are coated with the reinforcing resin 7.

The reinforcing resin 7 contains the thermosetting resin as a principal ingredient as mentioned previously and becomes thermally set in a heating process of the reflow device M7. Resin that is not thermally set and still exhibits fluidity when the solder paste 6 is thermally fused is selected as the reinforcing resin 7 employed in the present embodiment. Even when the electronic component 8 remains in contact with the reinforcing resin 7 in the reflow process during which the solder paste 6 is fused and solidified, horizontal movement of the electronic component 8 is allowed by means of fluidity of the reinforcing resin 7. Therefore, self-alignment action for correcting relative positional displacement of the electronic component 8 from the electrodes 5 of the bumps 9 is not hindered by surface tension of fused solder; namely, a fused solder component in the solder paste 6. A reinforcing resin exhibiting such a characteristic is already known as an adhesive for use with an electronic component (see; for instance, JP-A-2005-26502).

The head drive mechanism 33 is driven by a coating head drive section 35, and the positioning table 30 is driven by a table drive section 34. During the coating operation, a coating control section 37 controls the table drive section 34 and the coating head drive section 35 on the basis of coating data stored in a coating data storage section 36; namely, coating coordinates showing plan positions of the coating target areas on the substrate 4, thereby making it possible to control positions on the substrate 4 that are to be coated with the reinforcing resin by the coating head 32. Specifically, a control command value from the coating control section 37 becomes a control parameter for controlling the coating position. A display section 39 displays index data representing various operating statuses of the coating device M4 and an anomaly alarm showing an anomaly in the status of coating operation. A communication section 38 exchanges data with the management computer 3 and other apparatus making up the electronic component mounting line 1 by way of the communication network 2.

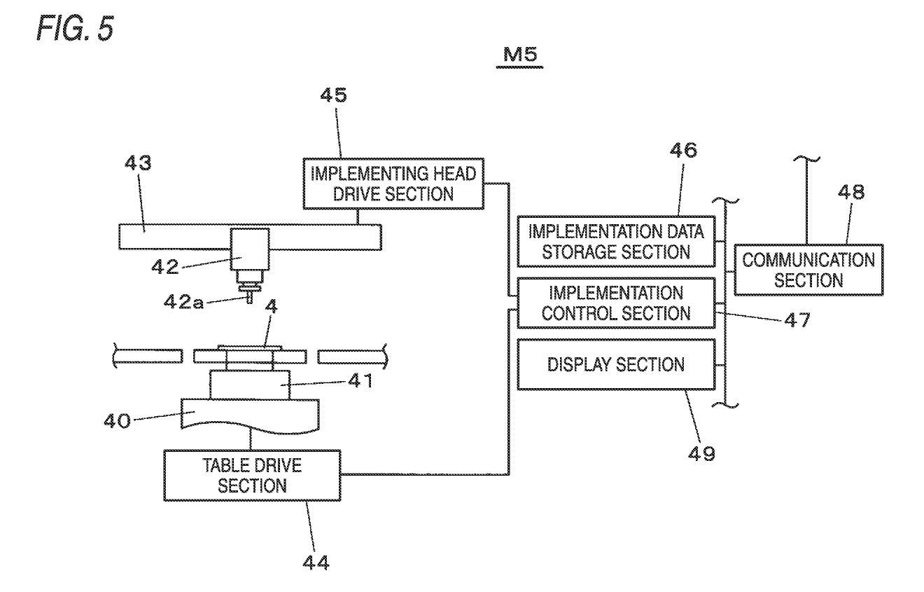

The configuration of the electronic component implementing device M5 is now described by reference to FIG. 5. In FIG. 5, a substrate retaining section 41 is placed on a positioning table 40, and the substrate retaining section 41 retains the substrate 4 conveyed from the coating device M4. An implementing head 42 that is moved by a head drive mechanism 43 is placed above the substrate retaining section 41. The implementing head 42 has a nozzle 42a for attracting an electronic component by suction. The implementing head 42 retains the electronic component 8 by suction and takes it out of a component feeding section (omitted from the drawings) by use of the nozzle 42a. The implementing head 42 is moved to a position above the substrate 4 and lowered with respect to the substrate 4, whereby the electronic component retained by the nozzle 42a is implemented on the substrate 4.

The head drive mechanism 43 is driven by an implementing head drive section 45, and the positioning table 40 is driven by a table drive section 44. During the implementing operation, an implementation control section 47 controls the table drive section 44 and the implementing head drive section 45 in accordance with the implementation data stored in an implementation data storage section 46; namely, mounting coordinates of the electronic component on the substrate 4, whereby a position on the substrate 4 where the implementing head 42 implements the electronic component can be controlled. Specifically, a control command value from the implementation control section 47 becomes a control parameter for controlling an implementing position. A display section 49 displays index data showing various operating statuses of the electronic component implementing device M5 and an anomaly alarm representing an anomaly in the status of implementing operation. A communication section 48 exchanges data with the management computer 3 and other devices making up the electronic component mounting line 1 by way of the communication network 2.

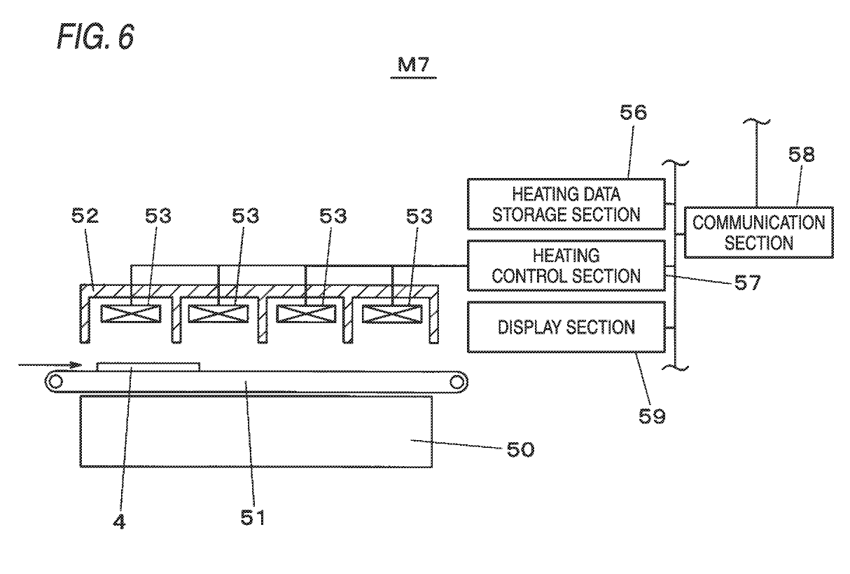

The configuration of the reflow device M7 is now described by reference to FIG. 6. In FIG. 6, a conveyance path 51 for conveying the substrate 4 is horizontally laid in a heating chamber 52 provided on a base 50. An interior of the heating chamber 52 is partitioned into a plurality of heating zones, and each of the heating zones is provided with a heating unit 53 having a temperature control function. The substrate 4 on which the electronic component 8 is implemented on the solder paste 6 is sequentially caused to pass through the respective heating zones from an upstream position while the respective heating zones are heated under predetermined temperature conditions by driving the heating unit 53, whereby a solder component in the solder paste 6 is heated and fused. The electronic component 8 is thereby soldered to the substrate 4.

In accordance with heating data stored in a heating data storage section 56; namely, a temperature command value that is a control parameter for realizing a temperature profile achieved in the reflow process, a heating control section 57 controls the respective heating unit 53 in the reflow process, whereby a desired temperature profile is set. A display section 59 displays index data representing operating statuses of the reflow device M7 and an anomaly alarm showing that a deviation from predetermined temperature conditions exceeds an allowable range and that heating operation is anomalous. A communication section 58 exchanges data with the management computer 3 and other apparatus making up the electronic component mounting line 1 by way of the communication network 2.

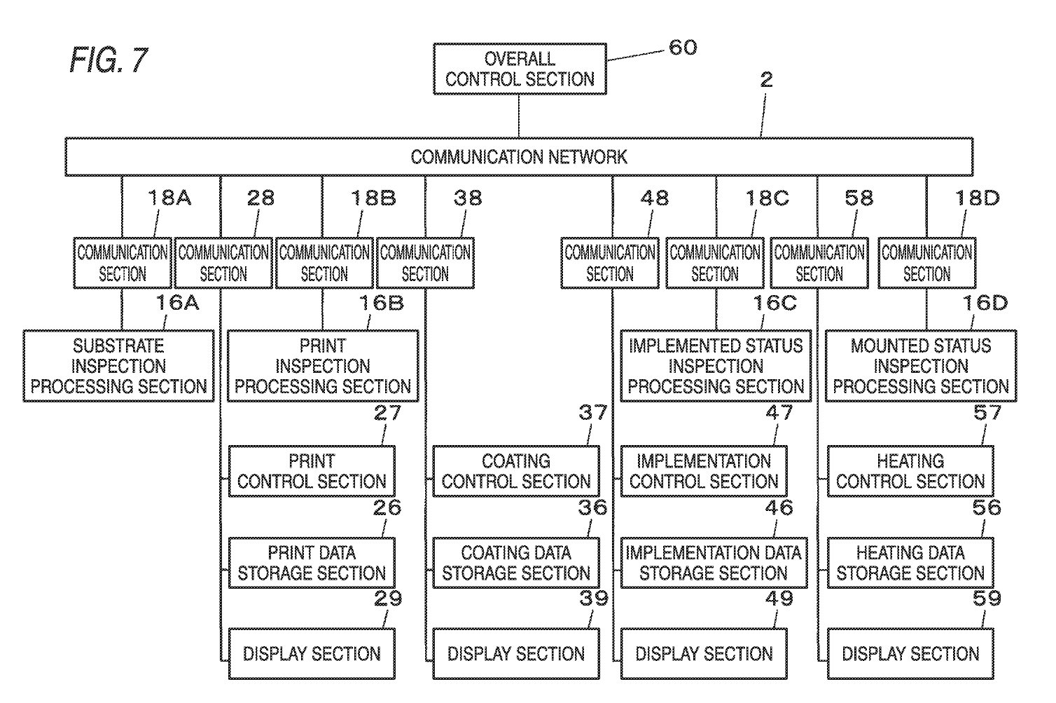

The configuration of the control system of the electronic component mounting system is now described by reference to FIG. 7. A data exchange function intended for quality control in electronic component mounting processes is now described. In FIG. 7, an entire control section 60 (entire control unit) exercises a quality control function in a range of control processing performed by the management computer 3. The entire control section 60 receives data transferred from the respective devices making up the electronic component mounting line by way of the communication network 2; performs required determination processing in accordance with a preset determination algorithm; and outputs a processing result as command data to the respective devices by way of the communication network 2.

A substrate inspection processing section 16A provided in the substrate inspection device M1 using the inspection device shown in FIG. 2 is connected to the communication network 2 by way of a communication section 18A. A print inspection processing section 16B provided in the print inspection device M3 using the inspection device shown in FIG. 2 is connected to the communication network 2 by way of a communication section 18B. An implemented status inspection processing section 16C provided in the implemented status inspection device M6 using the inspection device shown in FIG. 2 is connected to the communication network 2 by way of a communication section 18C. A mounted status inspection processing section 16D provided in the mounted status inspection device M8 using the inspection device shown in FIG. 2 is connected to the communication network 2 by way of a communication section 18D. Respective sections (see FIGS. 3, 4, 5, and 6) provided in the printing device M2, the coating device M4, the electronic component implementing device M5, and the reflow device M7 are connected to the communication network 2 by way of respective communication sections 28, 38, 48, and 58.

The electronic component mounting system is arranged so as to be able to perform, on the basis of the data extracted in any of the inspection processes, feedback processing for correcting and updating control parameters of upstream devices and feedforward processing for correcting and updating control parameters of downstream devices at any time during operation of the respective devices.

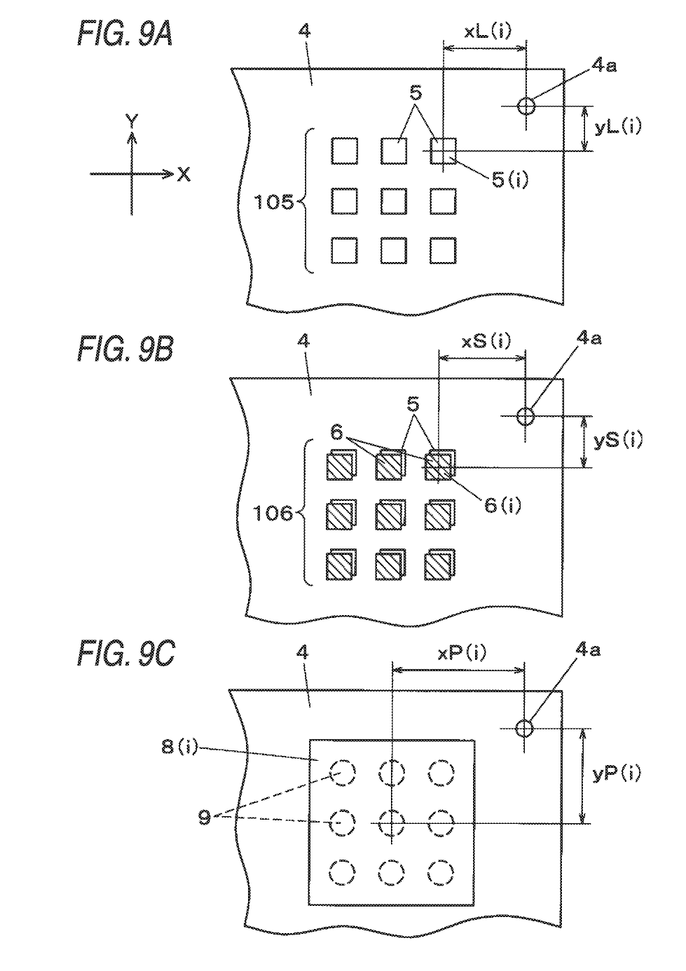

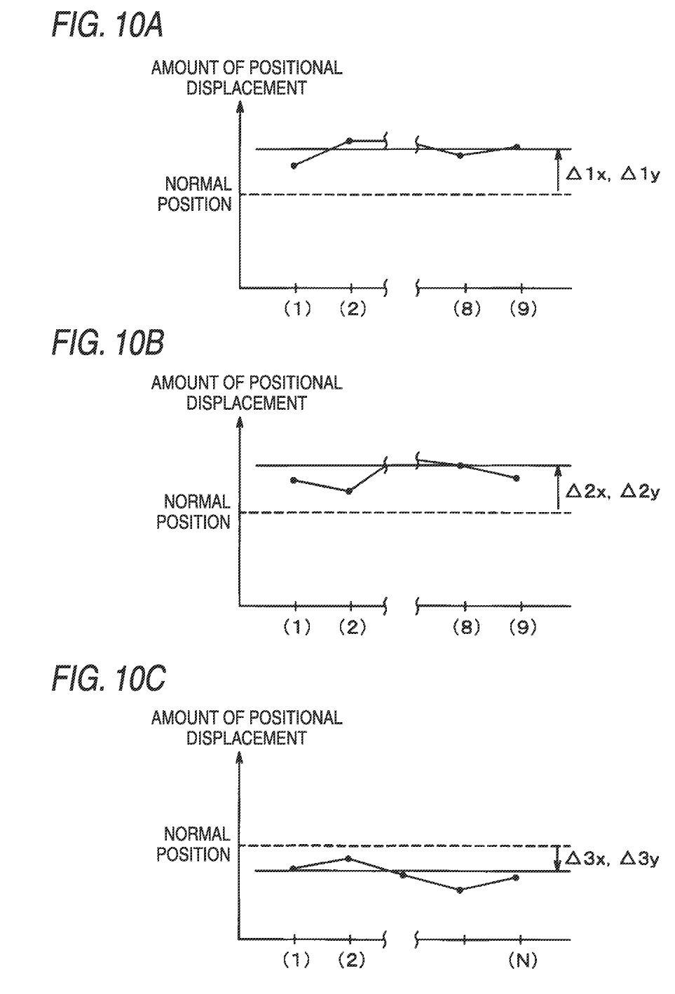

The electronic component mounting system is configured as mentioned above. Calibration performed under the electronic component mounting method and through the mounting processes; namely, processing for correcting and updating the control parameters, is hereunder described. The substrate 4 supplied from an unillustrated substrate supply section is first conveyed into the substrate inspection device M1 (see FIG. 2). The camera 13 captures an image of the substrate 4 in the device, to thus perceive an image and thereby ascertain the respective electrodes 5 formed on the substrate 4 as shown in FIG. 9A. There is illustrated an example in which an electrode group 105 into which a plurality of electrodes 5 corresponding to the respective bumps 9 of one electronic component 8 are combined on a per-component basis is taken as one recognition target. Positional data (electrode position data) showing the center of gravity of the respective electrodes 5 (see reference numerals 1 through 9 shown in FIG. 10A) are determined for each electrode group 105 as coordinate values xL(i) and yL(i) relative to a recognition mark 4a of the substrate 4. The data are then sent to the substrate inspection processing section 16A.

The substrate inspection processing section 16A performs inspection processing in accordance with a plurality of coordinate values determined for the respective electrodes 5. Specifically, the thus-determined coordinate values are subjected to statistic processing, thereby performing a pass/fail determination as to whether or not the substrate 4 is usable and determining a tendency of positional displacement of the electrodes 5 for each electrode group 105. As shown in FIG. 10A, when the amount of positional displacement between actual positions of the electrodes and normal positions of design data is tilted in a specific direction within an allowable range of variations, a deviation Δ1 representing the tilt is determined as numerical data [a direction-X deviation component Δ1(x) and a direction-Y deviation component Δ1(y)] for each electrode group 105.

There is performed feedforward processing for correcting the control parameters of the downstream devices by an amount corresponding to the deviation. The deviation data for use in feedforward processing are transferred to the communication network 2 by way of a communication section 18A. The entire control section 60 outputs, as a correction command value, to the printing device M2, the coating device M4, and the electronic component implementing device M5 located downstream. Although an example in which the electrode group 105 combining the electrodes 5 on a per-component basis is taken as one target is provided for the method of statistically processing positional data pertaining to electrodes, the electrodes 5 on the entire substrate 4 may also be taken as an object of statistic processing.

Next, the substrate 4 is conveyed into the printing device M2 and retained by the substrate retaining section 21, and the substrate 4 is printed with the solder paste 6. At this time, the correction command value based on the deviation data pertaining to the positions of the electrodes is stored in the print data storage section 26 by feedforward processing. When the substrate 4 is positioned with respect to the mask plate 22 by driving the positioning table 20, a correction is made to the amount of movement of the positioning table 20 on the basis of the correction command value. Even when positional displacement exists between the electrodes 5 and the normal positions relative to the recognition mark 4a of the substrate 4, the printing device M2 prints the solder paste 6 at the correct positions on the electrodes 5.

The substrate 4 undergone printing of solder paste is now conveyed to the print inspection device M3. In the embodiment, a similar inspection device determines position data representing the center of gravity of the solder paste 6 printed on each of the electrodes 5 (solder position data), as coordinate values xS(i) and yS(i) relative to the recognition mark 4a for each electrode 5 as shown in FIG. 9B, by image recognition. Likewise, there is provided an example in which a printed solder group 106 including the plurality of bundled pieces of solder paste 6 printed in correspondence with the respective bumps 9 of one electronic component 8 is taken as a recognition target. The print inspection processing section 16B likewise subjects recognition result to inspection processing, whereby a pass/fail determination of the print result and the tendency of positional displacement of the print positions are determined. As shown in FIG. 10B, a deviation Δ2 in positional displacement from the normal position is determined as numerical data [a direction-X deviation component Δ2(x) and a direction-Y deviation component Δ2(y)] for each printed solder group 106.

The deviation data acquired by print inspection are used for both feedback processing and feedforward processing. Specifically, the control parameter used in operation of the printing device M2 for printing the substrate 4 is compared with the print position detected by inspection, whereby positional displacement attributable to the printing device M2 can be determined. There is performed calibration for making a correction to the control parameter of the printing device M2 by an amount corresponding to positional displacement, whereby the amount of positional displacement in printing operation can be lessened. The deviation data pertaining to print position are fed forward to the coating device M4 and the electronic component implementing device M5 located downstream.

An area of a solder portion (a hatched portion on the electrode 5 shown in FIG. 9B) is computed for each electrode from imaging data pertaining to the solder paste printed on each of the electrodes 5, whereby the amount of solder print is detected for each electrode. When the detected amount of solder print varies in excess of an allowable range, setting of print conditions is determined to be defective, and a display to that effect is provided. The print conditions include squeegee speed for moving the squeegee 23c over the mask plate 22, a printing pressure value for pressing the squeegee 23c against the mask plate 22, a plate departing speed at which the substrate 4 is removed from a lower surface of the mask plate 22 after squeezing, and the like. Numerical data pertaining to print operation control are set as control parameters.

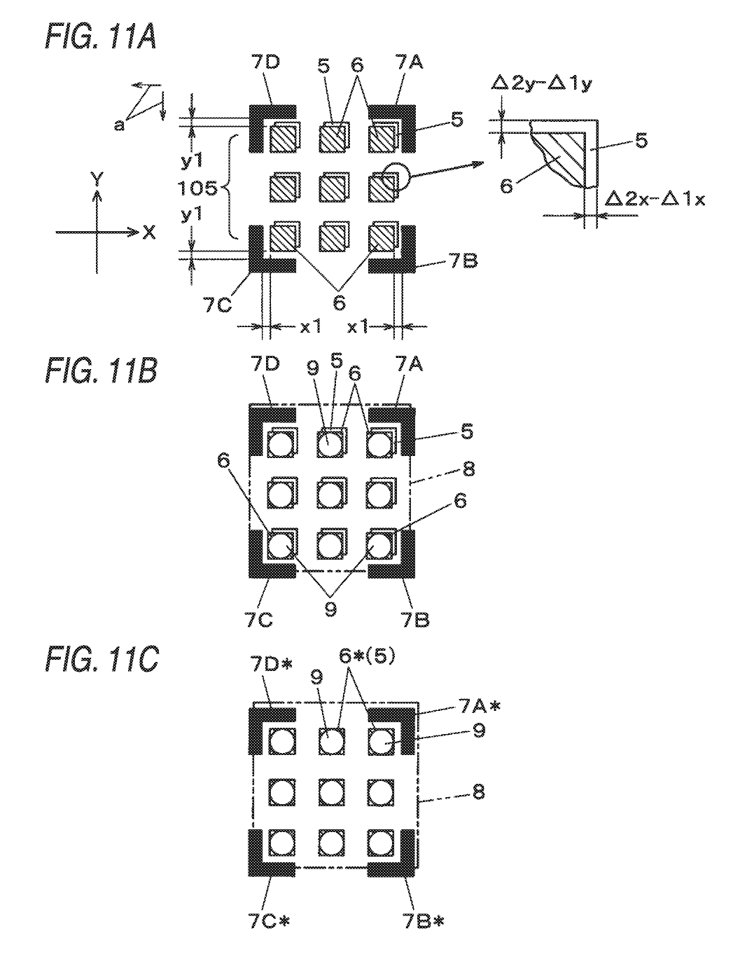

Next, the substrate 4 having undergone solder printing is conveyed into the coating device M4, where coating of the reinforcing resin 7 is performed. Specifically, as shown in FIG. 11A, respective corners of the electrode group 105 including the plurality of electrodes 5 corresponding to one electronic component 8 are coated with pieces of reinforcing resin 7A, 7B, 7C, and 7D. At this time, the electrodes 5 remain displaced on average from normal positions by Δ1x and Δ1y, and the pieces of solder paste 6 displace from the normal positions on average by Δ2x and Δ2y. Therefore, the pieces of solder paste 6 are positionally displaced from the electrodes 5 by Δ2x−Δ1x and Δ2y−Δ1y. There is provided an example in which the direction of positional displacement is on the negative side in the direction X and also on the negative side in the direction Y with reference to normal positions.

When the electrode group 105 in such a positionally-displaced state is coated with the reinforcing resin 7, positional corrections (designated by arrow “a”) are made such that the pieces of reinforcing resin 7A, 7B, 7C, and 7D are displaced toward the negative side in the direction X and the negative side in the direction Y by Δ2x and Δ2y with reference to the normal positions. Specifically, corrections are made to the control parameters directed toward the table drive section 34 and the coating head drive section 35 in such a way that a space x1 and a space y1, in both the directions X and Y, between the pieces of coated reinforcing resin 7A, 7B, 7C, and 7D and ends of the pieces of solder paste 6 printed on the electrodes 5 at corners proximal to the resin become substantially equal to each other.

In a state in which the pieces of printed solder paste 6 are positionally displaced from the normal positions, there can be prevented occurrence of a problem. Specifically, a problem which may arise when the reinforcing resin 7 is applied to the normal positions; namely, a problem of deterioration of a solder bonding characteristic of the solder paste 6, which would otherwise arise when the reinforcing resin 7 is partially mixed with the solder paste 6 as a result of the subsequently-applied reinforcing resin 7 contacting the previously-printed solder paste 6. During correction of the positions to be coated with the reinforcing resin 7, amounts of positional corrections are checked according to data and set in such a way that the pieces of applied reinforcing resin 7A, 7B, 7C, and 7D do not overlap the electrodes 5 situated at the corners. In the foregoing example, in a case where any of the pieces of reinforcing resin 7A, 7B, 7C, and 7D overlaps the corresponding electrode 5 when positional corrections are made by only Δ2x and Δ2y, the amounts of positional correction are reset in consideration of a relative position between the pieces of reinforcing resin and the corresponding electrodes 5.

The substrate 4 coated with the reinforcing resin 7 after having undergone solder printing is now conveyed into the electronic component implementing device M5, where component implementing operation is performed. The implementing head 42 picks up the electronic component 8 out of the component feeding section and brings the thus-picked-up electronic component on the bumps 9 by way of the solder paste 6 on the electrodes 5 and also brings the corners of the electronic component 8 into contact with the reinforcing resin 7 previously applied over the substrate 4. When the implementing head 42 implements the electronic component on the substrate 4, implementing operation is performed after the control parameters directed to the table drive section 44 and the implementing head drive section 45 have been corrected by amounts equivalent to the fed-forward deviations Δ2x and Δ2y. Even when the printing positions of the solder paste 6 are tilted as a whole, the bumps 9 for the electronic component 8 are implemented without involvement of positional displacement from the printed solder paste 6, as shown in FIG. 11B. In this state, the bumps 9 are positionally displaced from the electrodes 5.

The substrate 4 having the implemented electronic components is conveyed to the implemented status inspection device M6, where appearance check for inspecting an implemented status of the electronic components is performed. As shown in FIG. 9C, position data (component position data) showing the center of gravity of the electronic component 8 are determined as coordinate values xP(i) and yP(i) that take the recognition mark 4a as a reference, for each of the electronic components 8(i) on the substrate 4. The implemented status inspection processing section 16C subjects a result of recognition to inspection processing, whereby a pass/fail determination of an implemented status and the tendency of positional displacement of implemented positions are determined. Specifically, as shown in FIG. 10C, a deviation Δ3 in the amount of positional displacement from the normal position is determined as numerical data [a direction-X deviation component Δ3(x) and a direction-Y deviation component Δ3(y)] for each electronic component 8. The deviation data are likewise transferred to the communication network 2. The deviation data pertaining to the implementing positions are fed back to the electronic component implementing device M5, whereupon there is performed calibration for correcting the control parameters by an amount equivalent to the deviation Δ3. When the electronic components 8 are not implemented on the electrode 5; when the electronic component 8 is implemented not in a normal position but in an upright position; or when the electronic component is greatly displaced in the direction of rotation, the state of the electronic component is detected during recognition of an image. The detected state is determined to be an anomaly in the state of implementing operation. A display to that effect is provided.

The substrate 4 having the electronic components implemented thereon is conveyed to the reflow device M7, where the substrate 4 is heated according to a predetermined temperature profile, whereby a solder component in the solder paste 6 is fused. The bumps 9 are thereby soldered to the electrodes 5 by way of the solder-bonded portions 6* into which the solder paste 6 has become fused and solidified, and the electronic component 8 is held on the substrate 4 along the corners of the electronic component 8 by the resin reinforced portions 7* resultant from thermal setting of the reinforcing resin 7.

In the reflow process, even when the respective bumps 9 of the electronic component 8 are positionally displaced in the state shown in FIG. 11B, the fused solder component in the solder paste 6 wetly spreads over entire upper surfaces of the electrodes 5 by means of surface tension, thereby effecting self-alignment action of uniformly positioning the bumps 9 on upper surfaces of the respective electrodes 5. Consequently, as shown in FIG. 11C, the respective bumps 9 are soldered to the electrodes 5 by way of the solder-bonded portions 6* while correctly positioned to the substantial centers of the respective electrodes 5.

Since the reinforcing resin 7 has not yet finished being thermally set in a state where the solder component of the solder paste 6 is fused and exhibits fluidity, the respective corners of the electronic component 8 relatively move in the horizontal direction with respect to the pieces of reinforcing resin 7A, 7B, 7C, and 7D without hindering the self-alignment effect. Relative positions of the pieces of reinforcing resin 7A, 7B, 7C, and 7D achieved after self-alignment with respect to the respective corners of the electronic component 8 slightly change according to the corners. However, amounts of difference are nominal, and reinforcing action of the resin reinforced portions 7A*, 7B*, 7C*, and 7D* formed as a result of thermal setting of the reinforcing resin 7A, 7B, 7C, and 7D is not hindered.

In the embodiment shown in FIG. 11A, there is provided an example in which the same amount of positional correction is uniformly made, in the same direction, to the reinforcing resin 7A, 7B, 7C, and 7D corresponding to the respective corners of the electronic component 8. In light of an objective for making a positional correction to the coating positions of the reinforcing resin 7, it is not necessary to make a uniform positional correction to the pieces of reinforcing resin 7A, 7B, 7C, and 7D. Specifically, an objective of the positional correction is to prevent occurrence of an overlap between the solder paste 6 that has already been printed and the reinforcing resin 7 to be applied. In relation to the corners where an overlap does not arise between the solder paste 6 and the reinforcing resin 7 even when the reinforcing resin is applied to the normal positions, a correction does not need to be made to the coating positions of the reinforcing resin 7.

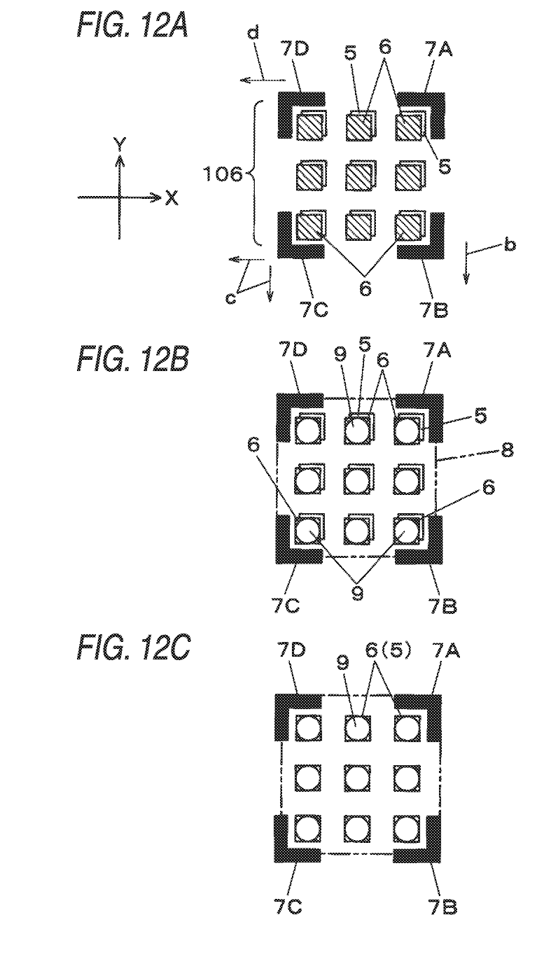

For instance, as shown in FIG. 12A, in a case where the solder paste 6 remains positionally displaced toward the negative side in both the direction X and the direction Y, an overlap does not arise between the solder paste 6 and the reinforcing resin 7 even when reinforcing resin 7A which is to become proximate to an upper right corner is applied as it is; therefore, the essential requirement is to apply the reinforcing resin to the normal positions. On the contrary, in relation to the reinforcing resin 7B, the solder paste 6 is displaced toward the negative side in the direction Y. A positional correction is made in only the negative side (designated by arrow “b”) in the direction Y. In relation to the reinforcing resin 7D, the solder paste 6 is positionally displaced toward the negative side in the direction X; hence, a positional correction is made solely to the negative side (designated by an arrow “d”) in the direction X.

In relation to the reinforcing resin 7C, the solder paste 6 is positionally displaced toward the negative side in both the direction X and the direction Y, and positional corrections are made in the negative side (designated by an arrow “c”) in both the direction X and the direction Y. In the example shown in FIG. 12A, a positional correction is made solely to the corners required to accomplish the objective for preventing occurrence of an overlap between the solder paste 6 already printed and the reinforcing resin 7 to be applied, thereby minimizing corrections to the coating positions of the reinforcing resin 7. When the control parameters used for controlling the coating device M4 are updated on the basis of the position data pertaining to the bonding material detected by the print inspection device M3, it is desirable to previously set an appropriate update pattern adequate for the objective of correction, in accordance with a degree to which a proximity of the solder paste 6 and the reinforcing resin 7 is allowed and the tendency of occurrence of positional displacement.

The electronic component 8 is next implemented on the substrate 4 coated with the reinforcing resin 7 as in the case with the embodiment shown in FIG. 11B. After a positional correction has been made at this time in such a way that the bumps 9 of the electronic component 8 are not positionally displaced from the solder paste 6, a correction is made to the position of the electronic component 8. Subsequently, the substrate 4 is conveyed into the reflow device M7. As in the case with the embodiment shown in FIG. 11C, the bumps 9 are soldered to the electrodes 5 by way of the solder bonded portions 6* into which the solder paste 6 is fused and solidified, and the electronic component 8 is held on the substrate 4 by the resin reinforced portions 7* into which the reinforcing resin 7 is thermally solidified. At this time, the respective bumps 9 of the electronic component 8 are soldered to the electrodes 5 by way of the solder bonded portions 6* while being correctly positioned to the electrodes 5 by similar self-alignment action of the fused solder, as shown in FIG. 12C.

With a view toward accomplishing the positional corrections, correction of the coating positions of the reinforcing resin 7 is reduced to the minimum required amount. Therefore, the degree of horizontal positional displacement of the respective corners of the electronic component 8 from the respective pieces of reinforcing resin 7A, 7B, 7C, and 7D becomes smaller than that achieved in the example shown in FIG. 11C. It has therefore become possible to accomplish correction of positions without hindering the reinforcing action of the resin reinforced portions 7A*, 7B*, 7C*, and 7D* resulting from thermal setting of the pieces of reinforcing resin 7A, 7B, 7C, and 7D.

The substrate 4 subjected to reflow treatment is conveyed into the mounted status inspection device M8, where the final mounted status of the electronic component 8 is inspected. Specifically, presence/absence of the electronic component 8 and presence/absence of an anomaly in the attitude and position of the electronic component 8 are inspected by external inspection. Of items to be inspected, a result of an inspection pertaining to a failure in heating state occurred in the reflow process is fed back to the reflow device M7, and a correction is made to the control parameters of the heating data storage section 56.

As mentioned above, an electronic component mounting method described in connection with the embodiment includes bonding material feeding process of feeding the solder paste 6 that is a bonding material to the electrodes 5 for bonding electronic components formed on the substrate 4 by the printing device M2; a bonding material position detection process of detecting position of the solder paste 6 fed during the bonding material feeding process by the print inspection device M3 and outputting a result of position detection as bonding material position data; a resin coating process of coating the substrate 4, which has been subjected to processing pertaining to the bonding material position detection process, with the reinforcing resin 7 that reinforces retaining force for retaining the electronic component 8 on the substrate 4 while the electronic component 8 is implemented, by the coating device M4 serving as a resin coating section; an implementing process of taking the electronic component 8 out of the component feeding section by the implementing head 42 of the electronic component implementing device M5 and implementing the electronic component 8 on the substrate 4 supplied with the solder paste 6 and additionally coated with the reinforcing resin 7; and a heating process of heating the substrate 4 by the reflow device M7 serving as solder bonding unit, to thus bond the implemented electronic component 8 to the substrate 4 by the solder paste 6 and thermally setting the reinforcing resin 7, to thus retain the electronic component 8 on the substrate 4.

In the resin coating process, the control parameters for controlling the coating device M4 are updated in accordance with the bonding material position data output in the bonding material position detection process. In a mounting mode in which the reinforcing resin 7 is used in conjunction with the solder paste 6 that is a bonding material, mixing of the solder paste 6 with the reinforcing resin 7 is thereby prevented, so that mounting quality can be assured.

Although the embodiment illustrates the example in which the present invention applies to the case where the corners of the electronic component 8 having on its undersurface the bumps 9 is reinforced by the reinforcing resin 7. The present invention can also apply to a case where the reinforcing resin 7 is applied to fix the center of a rectangular, miniature component, such as a chip component having at both ends thereof connection terminals, with an adhesive. Specifically, even in this case, a correction is made to the coating positions of the reinforcing resin according to the status of positional displacement of the solder paste 6 printed on the electrodes corresponding to the connection terminals, whereby mixing of the solder paste 6 with the reinforcing resin 7 can be prevented.

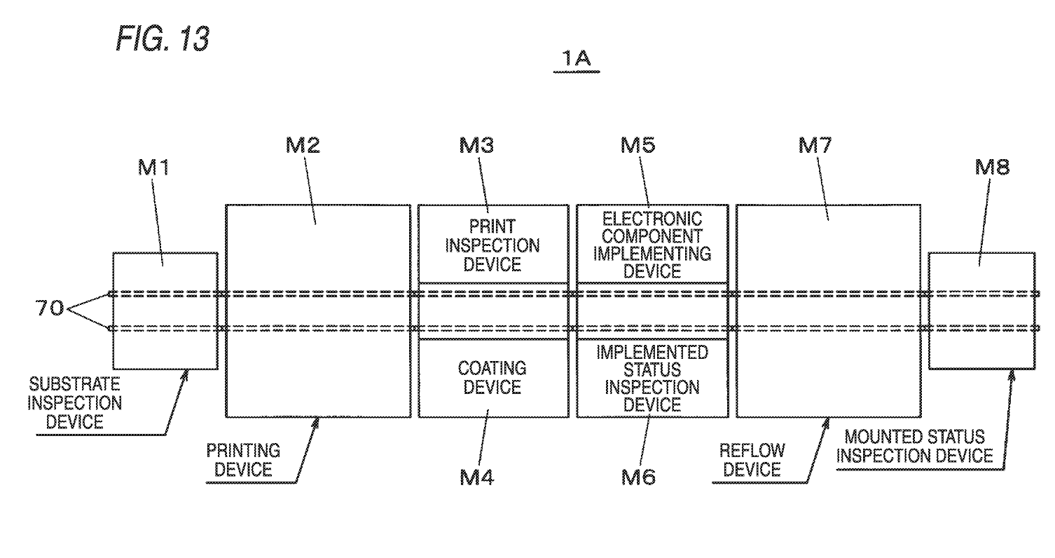

As shown in FIG. 1, the embodiment illustrates the example in which the electronic component mounting system is built from the electronic component mounting line 1 having the plurality of electronic component mounting devices arranged in series. However, the example configuration of the component mounting system of the present invention is not limited to the embodiment shown in FIG. 1, and many variations can be set. For instance, as in the case with an electronic component mounting line 1A shown in FIG. 13, there may also be a configuration in which working mechanisms are provided on both sides of a substrate conveyance mechanism 70 arranged in a direction of the line while electronic component mounting devices making up the line from the downstream printing device M2 to the upstream reflow device M7 are placed at the center of the line. There is shown an example configuration in which the print inspection device M3 and the coating device M4 are arranged opposite each other with the substrate conveyance mechanism 70 sandwiched therebetween and in which the electronic component implementing device M5 and the implemented status inspection device M6 are arranged opposite each other with the substrate conveyance mechanism 70 sandwiched therebetween. As a matter of course, so long as a facility configuration can realize the sequence of the processes described in connection with claim 1, the present invention can apply to the facility configuration other than the example configuration shown in FIG. 13.

The electronic component mounting method of the present invention yields an advantage of the ability to assure mounting quality in a mounting mode using a reinforcing resin in conjunction with a bonding material by preventing mixing of the bonding material with the reinforcing resin and is useful in a field where a mounting substrate is manufactured by bonding an electronic component to a substrate with a bonding material, such as solder paste.

What is claimed is:

1. An electronic component mounting method for manufacturing a mounted substrate by bonding electronic components to a substrate with a bonding material in an electronic component mounting system including a plurality of electronic component mounting devices, the method comprising:
a bonding material feeding process of feeding the bonding material to electrodes for bonding the electronic components formed on the substrate by a printing device;
a bonding material position detection process of detecting position of the bonding material fed in the bonding material feeding process by a print inspection device and outputting a result of position detection as bonding material position data;
a resin coating process of coating the substrate after the bonding material position detection process with reinforcing resin that reinforces retaining force for retaining the electronic components on the substrate such that the electronic components are implemented by a resin coating section;
an implementing process of taking the electronic components out of a component feeding section by an implementing head and implementing the electronic components on the substrate supplied with the bonding material and additionally coated with the reinforcing resin; and
a heating process of heating the substrate by a solder bonding unit, to thus bond the implemented electronic components to the substrate by the bonding material and thermally setting the reinforcing resin, to thus retain the electronic components on the substrate;
wherein control parameters for controlling the resin coating section are updated in the resin coating process in accordance with the bonding material position data.

2. The electronic component mounting method according to claim 1, wherein the bonding material is solder paste made by letting solder particles contain a flux component.

3. The electronic component mounting method according to claim 1, wherein the reinforcing resin is thermosetting resin applied to reinforce corners of the electronic component.
